(19) United States
(12) Patent Application Publication
(10) Pub. No.: US 2023/0405577 A1
(43) Pub. Date: Dec. 21, 2023

(54) System and Method for Multiplexed Dry Agent Addition

(71) Applicant: LMX MedTech LLC, Bloomfield, MI (US)

(72) Inventor: Michael J. Pugia, Pagosa Springs, CO (US)

(21) Appl. No.: 18/030,595

(22) PCT Filed: Oct. 8, 2021
(86) PCT No.: PCT/US21/54209

§ 371 Date: Apr. 6, 2023

Related U.S. Application Data
(60) Provisional application No. 63/089,308, filed on Oct. 8, 2020.

(51) Int. Cl. B01L 3/00

(52) U.S. Cl. CPC B01L 3/502; B01L 2200/16; B01L 2400/0487; B01L 2300/0681

(57) ABSTRACT

A system and method for bio-analysis of complex samples which enables processing, biomolecule capture, and/or immunoassay detection. The system, capable of operating with a low hydrodynamic force, has at least one capillary, at least one microwell, a filtration well, and a reagent well. The system is able to process whole blood, serum, plasma, urine, wound fluid, bronchial lavage, and sputum specimens, along with any other complex biological samples with volumes from 0.1 μL to 100 mL. Biomarkers can be whole cells or cell-free biomarkers.

### CROSS-REFERENCE TO RELATED APPLICATION

This application is the United States national phase of International Application No. PCT/US21/54209 filed Oct. 8, 2021, and claims priority to U.S. Provisional Patent Application No. 63/089,308, filed Oct. 8, 2020, the disclosures of which are hereby incorporated by reference in their entireties.

### BACKGROUND OF THE INVENTION

### Field of the Invention

The present disclosure relates to a system and method for bio-analysis of complex samples. Specifically, the disclosure relates to bio-analysis of complex samples which enable processing of biomolecule capture and immunoassay detection in a convenient format without user intervention. The present disclosure allows processing complex biological samples such as whole blood, serum, plasma, urine, wound fluid, bronchial lavage, and sputum specimens from 0.1 μL to 10 mL to allow capture and detection of cellular and cell-free biomarkers.

The technology serves to deliver small volumes of dry reagents for dilution, mixing and moving with samples and liquid reagents. The technology serves to allow the sample and reagents to be moved and held in multiple microsensor areas to enable multiplexed analysis of biomolecules with fewer reagents in smaller devices.

Affinity assays such as immunoassays typically require antibody dry reagents for capture and detection to be dried into a matrix such as a porous polymer, paper or membrane placed into a strip, cassette, or microfluidic format when used in the point of care setting. The sample to be analyzed is generally mixed with a liquid, either a buffer or the sample fluid itself, to dissolve the dry reagents before moving the dissolved reagents used for capture and detection of the analyte. This process becomes more complex when multiple analytes are detected in a multiplexed analysis. This process requires the dried reagents to work within the hydrodynamic forces of the format, such as the capillary force. In practice, adding drying reagents into a format raises issues by causing changes in the hydrodynamic forces of the format, leading to clogging and incomplete dissolution.

Therefore, a need exists for a solution wherein the dry reagent could easily be integrated into a format which maintains a consistent ability to process complex samples. The solution should eliminate the need for additional valves, mechanisms, or pumps to move liquid to the dry reagent for processing. Additionally, a solution that works for many different dry reagents without altering the format used for sample metering or liquid reagent addition would be highly desired.

### Description of Related Art

IBRI's PCT/US2020/055931 (the “IBRI PCT”), which is incorporated by reference in its entirety, has recently demonstrated a device format that could perform multiplexed analysis of biomolecules directly on complex samples using multiple analyte detection microwells for electrochemical detection of target analytes. The analyte detection microwell includes a porous surface with one or more pores, electrodes for electrochemical detection, and affinity agents for target analyte capture and detection which operate under low hydrodynamic force. The affinity agent for detection is attached to a reagent capable of generating an electrochemical label. The affinity agent for capture is attached to a reagent capable of binding a surface in the microwell. The electrochemical label is detected by a working electrode and a reference electrode placed in the microwell to measure the label formed by the affinity agent for detection. The format enables processing of biomolecule capture and immunoassay detection in a convenient format without user intervention to remove the filtration membrane.

The IBRI PCT design allows precise containment of the small sample volumes into an analyte detection microwell without loss of detection liquid, exposure to the environment, or the need for extraction and delivery into an analyzer. A microfluidic connecting capillary placed underneath multiple microwells holds liquid in the microwells for capture and detection of the analyte measured. The device operates after manual dilution and mixing of the sample with liquids and affinity reagents, such as antibodies used in an immunoassay. The liquid reagent allows the sample to be diluted and mixed with the affinity reagents to be used for capture and detection in the analyte detection microwell. Elimination of the manual dilution and mixing of the sample with liquids and affinity reagents is needed to allow the device to avoid any user intervention. Avoiding user intervention is preferred for use in the home testing and point-of-care testing settings. Avoiding the need for additional pumps, valves, mechanisms, and liquid dispensers is highly desired for miniaturization and ease of use.

The IBRI PCT device can be used with reagents for affinity assays such as electrochemical immunoassays (EC-IA), optical immunoassays (OP-IA), and mass spectrometric immunoassays (MS-IA) in the detection of cells and biomolecules trapped on the filtration membrane. In one example, polyclonal affinity reagents were used as a sandwich assay pair by placing an affinity label (biotin) on some of the polyclonal antibody and placing a detection method (ALP) on the remaining polyclonal antibody. This format allows the biomolecules to be immediately captured on the filtration membrane using neutravidin attached to capture microparticles trapped on the membrane surface. For multiplexed analysis, the filtration membrane is divided into multiple micro-wells with a filtration membrane bottom. Descriptions of the affinity assay utilized may be found in Pugia, M. J. et al., “Multiplexed SIERRA Assay for the Culture-Free Detection of Gram-Negative and Gram-Positive Bacteria and Antimicrobial Resistance Genes”, Anal Chem., 2021.

The IBRI PCT format uses a capillary stop as a mechanism for stopping and re-starting the flow of liquids and samples through the device. This capillary stop was previously disclosed in United States Patent Application Publication No. 2018/0283998, which is incorporated by reference in its entirety, (hereinafter “'998”) in FIG. 3. The '998 format includes a reaction well 14, the filtration membrane 15, and a capillary stop 16. When hydrodynamic force is applied in the waste collection chamber, the force drives the sample and liquid reagent fluids from the reaction well 14 through the filtration membrane 15 and the capillary stop 16. When hydrodynamic force is not applied, the capillary stop 16 is capable of holding sample and reacting fluids in the reaction well 14. The capillary has to be <300 micron to allow a stop function, and these diameters are small and prone to clogging when exposed to complex samples.

The steps for using the '998 format start by adding reagents mixed with sample and/or liquids by manual pipette or by a liquid dispensing system into the reagent well 14. The sample processing occurs by application of a hydrodynamic force in the waste collection chamber (FIGS. 3, 17) that drives the sample and liquid reagent fluids through the filtration membrane 15 in the reagent well 14 and then through the capillary stop 16 to waste. The vacuum or centrifugal force is used to generate a hydrodynamic force in the waste collection chamber at a desired strength to pull the sample and liquid reagent into the waste collection chamber.

In all cases, immunoassays require multiple incubation and wash steps, and the '998 device is limited to moving both the liquid and/or samples through both the filtration membrane 15 and the capillary stop 16. The pores of the filtration membrane 15 are small to allow isolation of cells of by size exclusion. Therefore, the pore diameters are small and prone to clogging when exposed to complex samples. The filtration membrane 15 must operate under greater hydrodynamic forces; therefore, the '998 system requires capturing the sample first on the membrane and moving the washed membrane to the '998 format to perform the immunoassay.

In practice, the reagents in liquids can have stability issues. For example, reagents such as antibodies for capture and detection must be stable in solutions stored at 4-8° C. or preferably room temperature for one or more years. Without long-term stability, the reagents need to be continuously replaced, causing waste and expense. Additionally, electrochemical reagents like p-amino-phenyl phosphate are very unstable and have to be prepared fresh, causing additional manual steps for the analyst.

Typically, dry reagents are used to overcome these stability issues. The chemicals used as the reactants are stabilized as dry reagents and are kept dry and away from damaging liquids until limmediately before use. The dry reagents are unitized, i.e., the reagents for each individual test are used and disposed of as a single entity. Dry chemistries are commonly used to hold assay ingredients in plastic surfaces, tablets, capillaries, or porous matrices. The addition of liquid at the time of use allows the dry reagents to be dissolved into the liquid and become a liquid reagent.

Dry reagents strive to be stable and immediately reactive when the sample and/or a liquid is added. Typically, dry reagents require polymers, surfactants, biomolecules, preservatives, desiccants, stabilizers, buffers, and other chemicals to stabilize the dry reagents to maintain reactivity of the analysis chemicals. These dry reagents are difficult to formulate and stabilize. Additionally, multiple dry reagents must be used for different assays, and each must be dissolved, mixed, and used together for multiplexed analysis. Dry reagents for each assay also can contaminate dry reagents for another assay if in proximity. The ideal dry reagents should not require additional chemicals and should be easy to keep stable and contamination free in, for example, the IBRI PCT device.

Multiplexed analysis is described in U.S. Pat. No. 7,125,711 to Pugia et al. (hereinafter “'711”) (see FIG. 2), where a microfluidic capillary (10) could be used to split samples into multiple additional capillary channels (11), which are directed to multiple areas (12) to meter the liquid to a volume for analysis. The fluid is then moved on to cavities with dry and liquid reagents (14). When hydrodynamic force is applied, the force drives the sample from the metering areas and on to cavities (14) for reactions of the sample with reagents for analysis, and finally, to waste (20).

The '711 design also demonstrates that an additional air vent (16) (see FIG. 4) is needed to segment the microfluidic capillary used to split samples so that only the metered liquid volume exits the metering areas on to the cavities. The small microfluidic capillaries, of <100 μm, are used to split a sample and can become easily clogged when processing complex samples, therefore requiring removal of debris from the sample prior to application and are thus impractical for complex samples >1 μL volumes. Additionally, adjusting the volume of liquid reagents used for mixing requires creating a specific new plastic part for each adjustment.

Therefore, a need exists to dissolve, mix, and separate assay ingredients for multiplexed analysis. The assay ingredients should easily be integrated into the current IBRI PCT format, and the format should maintain the ability to process complex samples with little or no intervention. The assay method should allow complex samples of 0.1 μL to 100 mL volumes without adjusting the volume of liquid reagents and having to create a specific new plastic part for every volume used. Additionally, the method should avoid the use of capillaries or cavities for dry reagent metering that would clog or require additional operator intervention to utilize the IBRI PCT device. Ideally, the method should not need additional valves and/or pumps for mixing dry reagent with sample or liquid reagents.

Additionally, applying the present disclosure with the device of IBRI PCT should allow using the multiple analyte detection microwells for electrochemical detection and operating under one common hydrodynamic force used to stop and start liquid flow in the multiple analyte detection microwells. One common liquid source to dilute a sample and reconstitute the dry reagents should avoid additional venting, dispensing, or other interventions. The dry reagent delivery method should pass large-sized debris and yet still hold and release a dissolved reagent in incubating, mixing, and washing steps needed for affinity and separation protocols.

### SUMMARY OF THE INVENTION

An object of the present disclosure is to place dry reagent in a well above each analyte detection microwell such that the hydrodynamic force needed to break the porous surface that resides in the bottom analyte detection microwells is not altered. The dry reagent wells can be fed with a liquid reagent from one or more reagent wells and exit the bottom of the dry reagent wells into the analyte detection microwell. The bottom of this analyte detection microwell includes a porous surface with 1 or more pores, electrodes, and affinity capture materials and operates under low hydrodynamic force. The dry reagent wells should be of a sufficient size to hold the dry reagent, to allow mixing with a liquid reagent, and to not be clogged with a complex sample or impact the hydrodynamic force needed to break the porous surface in the analyte detection microwell and move to waste the connecting capillary in the filtration well. One or more common liquids can be added to all dry reagent wells from above the analyte detection microwell via the common hydrodynamic force.

In non-limiting embodiments or examples, the analyte detection microwell with a captured and/or detected analyte in the analyte detection microwell is removed for additional processing steps. In non-limiting embodiments, the affinity agent for detection is attached to a reagent capable of generating an electrochemical label. In some non-limiting embodiments, the affinity agent for capture is attached to a reagent capable of binding a surface in the microwell. The electrochemical label is detected by a working and reference/counter electrode placed in the microwell to measure the label formed by the affinity agent for detection.

Further non-limiting embodiments or examples are set forth in the following numbered clauses.

Clause 1: A device for dissolving and mixing dry reagents with liquids by moving a liquid from a reagent well into dry reagent wells and exiting into and out of an analyte detection microwell.

Clause 2: The device of clause 1, wherein liquids exit into and out of the analyte detection microwell through a connecting capillary placed in a filtration well.

Clause 3: The device of any of clauses 1 or 2, wherein the dry reagent wells can be fed with a common liquid reagent from a reagent well and exit the bottom of the dry reagent wells into analyte detection microwells of sufficient size to hold the reagent to cause mixing with the liquid reagent.

Clause 4: The device of any of clauses 1-3, further comprising two or more dry reagent wells and two or more analyte detection microwells.

Clause 5: The device of any of clauses 1-4, wherein more than one liquid moves into the one or more dry reagent wells from one or more reagent wells.

Clause 6: The device of any of clauses 1-5, wherein the liquid enters and exits the reagent well through capillaries placed just before a dry reagent well entrance and after dry reagent well exit of the dry reagent well.

Clause 7: The device of any of clauses 1-6, wherein the capillaries placed just before the dry reagent well entrance and after the dry reagent well exit the dry reagent well are adjusted in size and/or shape to better to hold and mix the dry reagent.

Clause 8: The device of any of clauses 1-7, wherein the capillaries placed just before the dry reagent well entrance and after the dry reagent well exit of the dry reagent well are adjusted in size and/or shape so as to not alter the hydrodynamic force of the porous surface placed in the bottom of the analyte detection microwell.

Clause 9: The device of any of clauses 1-8, wherein the reagent well can be vented to allow liquids to be released into the dry reagent well.

Clause 10: The device of any of clauses 1-9, wherein the dry reagent well and the reagent well can be sealed to prevent moisture in the air from entering.

Clause 11: The method of clause 10, further comprising applying a hydrodynamic force below one or more analyte detection microwells, a filtration well, and the one or more dry reagent wells.

Clause 12: The method of either of clauses 10 or 11, further comprising adding a liquid reagent for dissolving a dry reagent in the one or more dry reagent wells.

Clause 13: The method of either of clauses 10-12, further comprising holding the liquid reagent for incubation in the filtration well.

Clause 14: The method of any of clauses 10-13, wherein the liquid reagent moves remaining dry reagent by a hydrodynamic force.

Clause 15: The method of any of clauses 10-14, wherein the one or more dry reagent wells comprise a first and a second set of dry reagent wells.

Clause 16: The method of any of clauses 10-15, wherein a reagent in the second set of dry reagent wells dissolves dry reagent in the first set of dry reagent wells.

Clause 17: The method of any of clauses 10-16, wherein the second set of dry reagent wells is placed atop the first set of dry reagent wells.

Clause 18: The method of any of clauses 10-17, further comprising one or more reagent wells, the reagent wells configured to direct liquid to the one or more dry reagent wells.

Clause 19: The method of any of clauses 10-18, further comprising releasing liquid into one or more of the dry reagent wells and applying a hydrodynamic force below the one or more dry reagent wells.

These and other features and characteristics of the present disclosure, as well as the methods of operation and functions of the related elements of structures and the combination of parts will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1 shows a cross-sectional view of the dry reagent delivery system in accordance with a non-limiting embodiment or example of the invention.

FIG. 2 shows a cross-sectional view of the dry reagent delivery system in accordance with a non-limiting embodiment or example of the invention.

FIG. 3 shows a cross-sectional view of a dry reagent delivery system in accordance with a non-limiting embodiment or example of the invention.

FIG. 4 shows a cross-sectional view of the dry reagent delivery system in accordance with a non-limiting embodiment or example of the invention.

FIG. 5 shows a cross-sectional view of the dry reagent delivery system in accordance with a non-limiting embodiment or example of the invention.

FIG. 6 shows a cross-sectional view of the dry reagent delivery system in accordance with a non-limiting embodiment or example of the invention.

### DESCRIPTION OF THE INVENTION

For the purpose of promoting an understanding of the principles of the invention, reference will now be made to the embodiments illustrated in the drawings, wherein like reference numbers correspond to like or functionally equivalent elements, and specific language will be used to describe the same. It will nevertheless be understood that no limitation of the scope of the invention is thereby intended. Any alterations and further modifications in the described embodiments, and any further applications of the principles of the invention as described herein, are contemplated as would normally occur to one skilled in the art to which the invention relates. Certain embodiments of the invention are shown in detail, but some features that are well known or that are not relevant to the present invention may not be shown for the sake of conciseness and clarity.

For purposes of the description hereinafter, the terms “end,” “upper,” “lower,” “right,” “left,” “vertical,” “horizontal,” “top,” “bottom,” “lateral,” “longitudinal,” “forward,” “reverse” and derivatives thereof shall relate to the example(s) as oriented in the drawing figures. However, it is to be understood that the example(s) may assume various alternative variations and step sequences, except where expressly specified to the contrary. It is also to be understood that the specific example(s) illustrated in the attached drawings and described in the following specification are simply exemplary examples or aspects of the invention. Hence, the specific examples or aspects disclosed herein are not to be construed as limiting. Moreover, as used in the specification and the claims, the singular forms of terms include plural referents unless the context clearly dictates otherwise.

For purposes of the description hereinafter, an analyte detection microwell (3) for electrochemical detection of target analytes is described in accordance with the IBRI PCT. The target analyte, porous surface, detection microwell, electrochemical detector, and affinity agents for a target analyte for capture and detection are defined as terms and examples in accordance with the IBRI PCT. The materials and methods described herein are useful with any of a broad variety of target analytes. The target analytes include a wide range of target molecules and target cells. In addition, the target analytes may comprise one or more target variants, as described hereinafter.

For purposes of the description hereinafter, the material used for housing for liquid or dry reagents in wells or capillaries may be molded or constructed from film layers using plastic materials or other non-porous materials such as glass or metals. Examples of plastic materials for fabricating the housing include polystyrene, polyalkylene, polycarbonate, polyolefins, epoxies, Teflon®, PET, cyclo olefin polymer (COP), cyclo olefin copolymer (COC) such as Topas®, chloro-fluoroethylenes, polyvinylidene fluoride, PE-TFE, PE-CTFE, liquid crystal polymers, Mylar®, polyester, polymethylpentene, polyether ketone (PEEK), polyphenylene sulfide, and PVC plastic films. The plastics can be metallized such as with aluminum. The housing strives to have relative low moisture transmission rates, e.g., 0.001 mg per m²-day. The housing allows venting to air at the time of use by opening a vent hole in the housing, e.g., by puncture of the housing or removal of the plug. The materials for fabrication may also include a porous matrix materials placed inside the housing which is bibulous and includes fibrous materials such as cellulose (including paper), nitrocellulose, cellulose acetate, rayon, diacetate, lignins, mineral fibers, fibrous proteins, collagens, synthetic fibers (such as nylons, dacron, olefin, acrylic, or polyester fibers, for example) or other fibrous materials (glass fiber, or metallic fibers). For purposes of the description hereinafter, the physical dimension used for the three planar surfaces that fabricate the analyte detection microwell can have varying layer thickness, for example of 25 to 5000 μm (1 mil is 25.4 μm) and number of microwells from 1 to 1000. Each microwell can have varying pore diameters, for example 50 to 1000 μm, varying pore numbers, for example 1 to 1000 pores per microwell, and varying microwell diameters and height, for example at least 50 μm to up to 1 cm In some non-limiting examples, there are eight 100 μm diameter pores with an area of 0.063 mm\hat{ }2 per microwell. In some non-limiting examples, slots, e.g of 50×100 μm, are used as pores. In some non-limiting examples, there are four 200 micron diameter pores with an porosity of 0.128 mm\hat{ }2 per microwell. In some non-limiting examples, microwell have diameters of 2000 μm and heights of 3000 μm with a bottom reactive metal area of 3.14 mm\hat{ }2 per microwell and a microwell volume of 9.4 μL. In some non-limiting examples, microwell have diameters of 2000 μm and heights of 5000 μm with a bottom reactive metal area of 3.14 mm\hat{ }2 per microwell and a microwell volume of 129 μL. In some non-limiting examples, 2% of the reactive metal surface area may have pores. In some non-limiting examples, 25% of the reactive metal surface area may have pores

The housing of liquid or dry reagents may be comprised of several pieces permanently fixed by adhesion using thermal bonding or mechanical fastening or through use of permanent adhesives such as drying adhesive like polyvinyl acetate, pressure-sensitive adhesives like acrylate-based polymers, contact adhesives like natural rubber and polychloroprene, hot melt adhesives like ethylene-vinyl acetates, and reactive adhesives like polyester, polyol, acrylic, epoxies, polyimides, silicone-based rubber, and modified acrylate and polyurethane compositions, or natural adhesive like dextrin, casein, or lignin. The plastic film or the adhesive can be made of electrically conductive materials and metal coated. The conductive coating, film, or adhesive materials can be patterned across specific regions of the holder surface.

The dried reagents may include chemicals to perform the analysis, such as affinity agents for the capture and detection of cells and biomolecules and electrochemical signal generating reagents. Affinity agents are binding agents that are specific for a cell or biomolecule. The phrase “binding partner” refers to a molecule that is a member of a specific binding pair. A member of a specific binding pair is one of two different molecules which specifically binds to a cell or biomolecule. The members of the specific binding agents may be members of immunological reagents such as antigen-antibody or hapten-antibody, or other biochemicals such as biotin-avidin, hormones-hormone receptors, enzyme-substrate, nucleic acid duplexes, IgG-protein A, and polynucleotide pairs such as DNA-DNA, RNA-RNA, DNA-RNA, or oligo poly nucleotides like poly T or poly A.

The dried reagents may include additives such as polymers, surfactants, biomolecules, preservatives, desiccants, stabilizers, buffers, and other chemicals to stabilize the dry reagents to maintain reactivity of the analysis chemicals. Additives may be chosen from a wide variety of materials, which may be naturally occurring, or synthetic material. Illustrative additives may further include, but are not limited to, carbohydrates, amino acids, lipids, vitamins, co-factors, buffers, antioxidants, proteins, salts, and buffers. Other non-limiting additives include micro-particles, nanoparticles, and forms thereof. The dried reagents may include particles comprised of polymers, carbon, metal, colloids, dendrimers, dendrons, nucleic acids, branch chain-DNA, and liposomes.

The dry reagents can be dried by heating or lyophilization. Lyophilization is a freeze-drying process in which water is removed from a product after it is frozen and placed under a vacuum, allowing the ice to change directly from solid to vapor without passing through a liquid phase. The dried reagents may optionally include additives which maintain reactivity of the analysis chemicals after lyophilization like cryoprotectants, carbohydrates like lactose, trehalose, sucrose, and other sugars.

The liquid reagents may generally also include chemicals needed to perform the analysis such as agents for preparing samples for binding affinity agents, and electrochemical signal generating reagents. Agents for preparing samples may include lysis agents to break cells and release biomolecules. Illustrative examples of lysis agents may include, but are not limited to, non-ionic detergents, e.g., saponin, TRITON® X-100, and TWEEN®-20, anionic detergents, amphoteric detergents, or low ionic strength aqueous solutions (hypotonic solutions). Agents for preparing samples also may include buffers to achieve the desired pH and maintain the pH for binding affinity agents during any incubation period. Illustrative buffers may include, but are not limited to, borate, bicarbonate, phosphate (e.g., phosphate buffered saline), carbonate, TRIS, barbital, PIPES, HEPES, MES, ACES, MOPS, and BICINE. Agents for preparing samples may also include a fixation agent, a permeabilization agent, and a blocking agent to promote specific binding to the cells. Agents for preparing samples can also include a blocking agent, such as a protein or surfactant, to reduce non-specific binding to the format.

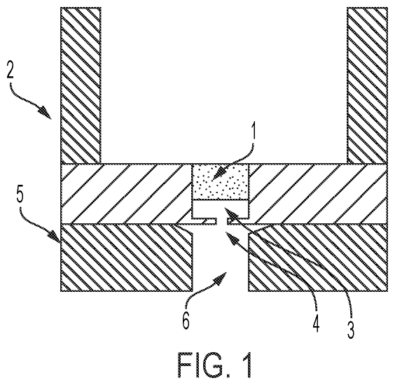

FIGS. 1-6, with reference numbers which correspond to elements or functionally equivalent elements of the device, exemplify a system and method for sample collection and metering according to non-limiting embodiments or examples of the current invention. According to non-limiting embodiments or examples, the system and method for sample collection and metering may include a dry reagent well (1), a liquid reagent well (2), and an analyte detection microwell (3) for electrochemical detection of target analytes. The analyte detection microwell (3) may further include a porous surface with one or more pores (4) of >100 microns and electrodes for electrochemical detection. The system and method for sample collection and metering may operate under low hydrodynamic force without clogging with debris by allowing fluid connection to a filtration well (5) with a microfluidic connecting capillary (6) that allows waste to exit.

In FIG. 1 there is shown, in schematic form, a non-limiting embodiment or example of the dry reagent well (1) that is placed below a reagent well (2), which is used for addition of samples and/or liquids, and above the analyte detection microwell (3), which contains a porous surface containing one or more pores (4). The analyte detection microwell (3) may also include an electrochemical detector area with affinity agents for analyte capture and detection, and may operate under low hydrodynamic force. A dry reagent well (1) is configured to hold a dry reagent and allow a liquid reagent from the reagent well (2) to enter the analyte detection microwell (3) and exit through one or more pores (4) toward the filtration well (5) and out through the microfluidic connecting capillary (6). FIG. 1 shows the dry reagent well (1) component in a vertical orientation, as a cross-section of a cylinder. However, it is appreciated that the component can be in other geometries, such as a cube or polygonal prism, or other orientations, such as horizontal or angled.

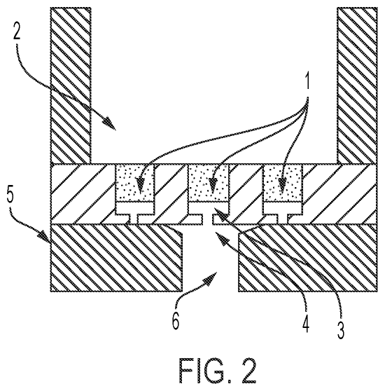

In FIG. 2 there is shown, in schematic form, a non-limiting embodiment or example of multiple dry reagent wells (1) placed below a reagent well (2) used for addition of samples and/or liquids. Each dry reagent well (1) is placed above a separate analyte detection microwell (3) which may contain a porous surface containing one or more pores (4). The analyte detection microwells (3) may also include electrochemical detector areas with affinity agents for analyte capture and detection, and may operate under low hydrodynamic force. The dry reagent wells (1) may each hold unique assay ingredients and may each allow a liquid reagent from the reagent well (2) to mix with each individual dry reagent well (1) and to enter separately the electrochemical detector wells (3) and exit through one or more pores (4) toward the filtration well (5) and out through a common microfluidic connecting capillary (6).

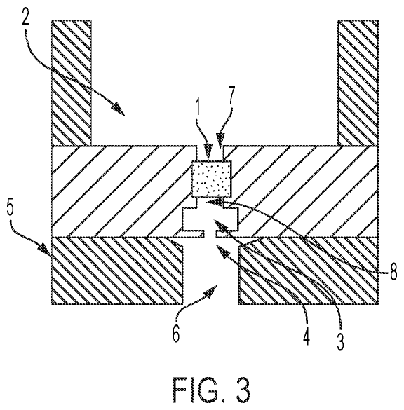

FIG. 3 shows a cross-sectional view of a dry reagent delivery system in accordance with a non-limiting embodiment or example of the invention where the dry reagent well (1) and analyte detection microwell (3) are housed between the reagent well (2) and filtration well (5) containing a microfluidic connecting capillary (6). The analyte detection microwell (3) may have one or more pores (4) and may empty under low hydrodynamic force equal to or less than the microfluidic connecting capillary (6). A dry reagent is added to the dry reagent well (1) and to the analyte detection microwell (3) by addition of a liquid reagent to the reagent well (2). The reagent may exit the analyte detection microwell (3) through the filtration well (5) with the microfluidic connecting capillary (6) via an application of hydrodynamic force. The well diameters of the dry reagent well entrance (7) and the dry reagent well exit (8) the of the dry reagent well (1) may be adjusted in size and/or shape to better to hold the dry reagent and to better mix the dry reagent with the liquid reagent before entering the analyte detection microwell (3).

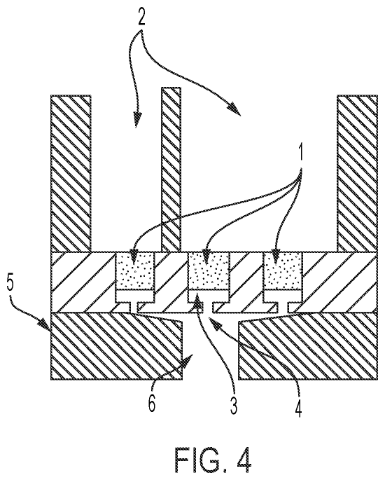

FIG. 4 shows a cross-sectional view of the dry reagent delivery system in accordance with a non-limiting embodiment or example of the invention where there are more than one reagent wells (2) used to house and feed different analyte detection microwells (3) and one filtration well (5) containing a microfluidic connecting capillary (6) able to empty all analyte detection microwells (3). Each analyte detection microwell (3) may include an electrochemical detector with affinity agents for analyte capture and detection, and may include one or more pores (4). The analyte detection microwells (3) with electrochemical detectors may operate under low hydrodynamic force. A dry reagent well entrance (7, not shown) may be added to the top of the dry reagent well (1) to further facilitate the movement of the liquid reagent from the dry reagent well (1) to enter the analyte detection microwells (3), which may contain the electrochemical detectors, and exit the filtration well (5) through the microfluidic connecting capillary (6). A dry reagent well exit (8, not shown) may be placed between the dry reagent well (1) and the one or more pores (4) to further facilitate the movement of the liquid agent.

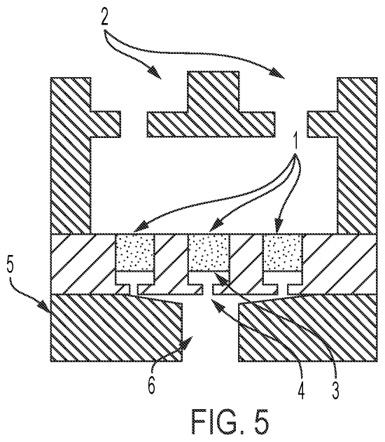

FIG. 5 shows a cross-sectional view of the dry reagent delivery system in accordance with a non-limiting embodiment or example of the invention where multiple reagent wells (2) feed multiple analyte detection microwells (3) with liquids. Each analyte detection microwell (3) may include an electrochemical detector with affinity agents for biomolecule capture and detection. Each analyte detection microwell (3) may include one or more pores (4), which empty into the filtration well (5) containing a microfluidic connecting capillary (6) upon application of a hydrodynamic force. The dry reagent in the dry reagent well (1) mixes with liquid reagent from the reagent well (2) and enters the analyte detection microwells (3) with the electrochemical detector, enters the filtration well (5) through the one or more pores (4), and exits through the microfluidic connecting capillary (6).

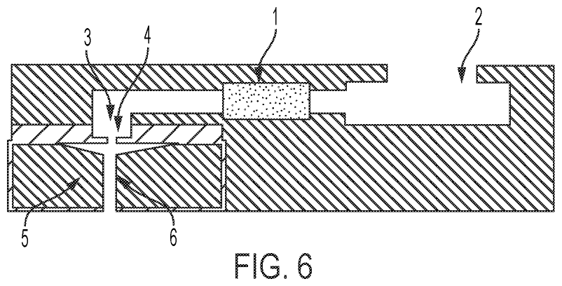

FIG. 6 shows a cross-sectional view of a non-limiting example of the dry reagent delivery system in a horizontal orientation where the dry reagent well (1) is connected to the reagent well (2), the analyte detection microwell (3), and the filtration well (5) containing a microfluidic connecting capillary (6). The analyte detection microwell (3) may include an electrochemical detector and one or more pores (4). The dry reagent well (1) may hold affinity agents for analyte capture and detection in the path of samples and/or liquid from the reagent well (2), and the reagent is dissolved before entering the analyte detection microwell (3). The reagent exits the one or more pores (4) into the filtration well (5) and exits through the microfluidic connecting capillary (6). It is appreciated that the delivery system may be in numerous other orientations and configurations as long as the path of the sample, as discussed above, is feasible.

In a non-limiting embodiment or example, dissolving and mixing dry reagents with liquids occurs during movement of a liquid from a reagent well (2) into and out of dry reagent wells (1), into the analyte detection microwell (3) with one or more pores (4), and out through the connecting capillary (6) of the filtration well (5). The dry reagent well (1), reagent well (2), analyte detection microwell (3), filtration well (5), and connecting capillary (6) may be assembled as one sealed device that is single use, as in once per sample or assay, but has a long stability as it is sealed and protected from moisture.

In another non-limiting embodiment or example, the dry reagent wells (1) may allow dissolving and mixing of the dry reagents with liquids upon movement of liquid from a reagent well (2) into dry reagent wells (1), through the one or more pores (4) of the analyte detection microwell (3), and into the connecting capillary (6) placed in a filtration well (5). The size and/or shape of the dry reagent well (1) does not alter the hydrodynamic force of the porous surface of the microwell (3). Once the hydrodynamic force is removed, the liquid does not exit the porous surface of the microwell (3) and liquid remains in the analyte detection microwell (3) and/or the filtration well (5). In some non-limiting examples, a dry reagent well entrance (7) and/or a dry reagent well exit (8) may be added around the dry reagent well (1) to allow the dry reagent to be better dissolved and mixed with the liquid reagent. The dry reagent well entrance (7) and/or the dry reagent well exit (8) do not alter the hydrodynamic force porous surface of the microwell (3).

In one non-limiting embodiment or example, the vacuum applied to the system is vented to pressurize the air in the reagent well (2) to allow liquids to be released to the dry reagent well (1) and to move through the dry reagent well (1) and out of one or more pores (4) of an analyte detection microwell (3) to the connecting capillary (6) placed in a filtration well (5). The application of the vacuum may be stopped to hold the liquid for a period of time in the analyte detection microwell (3) and then reapplied to move liquid out of the analyte detection microwell (3).

### EXAMPLE 1: METHOD FOR MULTIPLEXED DRY REAGENT ADDITION

### Materials

| | |
|---|---|
| Analyte | Analyte detection microwell of 110 and 200 -μm |
| detection | diameters and 300 μm depths were made using |
| microwell | standard microfabrication photolithography |
| (5) | techniques described below. Analyte detection |
| | microwells of 2000 μm diameters and 300 μm depths |
| | were fabricated under contract by Vishay (Shelton, CT) |
| | to design CAD produced by BioMEMS Diagnostic INC |
| Reagent well | The reagent well and filtration well were produced |
| (2) and | by CNS milling of PEEK by fictiv (San Francisco, |
| filtration well | CA) according to design CAD produced by produced |
| (5) with a | by BioMEMS Diagnostic INC as BioMEMS REAGENT |
| connecting | WELL, and BioMEMS FILTRATION WELL, which all |
| capillary (6) | are representative of the design in FIG. 1 as |
| | shown in a vertical cylinder orientation. |
| | Connecting capillary (6) at the bottom of the |
| | filtration well was >1 mm diameter and varied |
| | in length for a connecting to the waste chamber |
| | and vacuum. The reagent well for liquids has a |
| | diameter of 9.5 mm and a height of 14.5 mm for |
| | a usable volume of 1.1 mL. |
| Dry reagent | Analyte detection sensors were fabricated by Vishay |
| wells (1) | (Shelton, CT) as described in IBRI PCT. The analyte |
| with electro- | detection microwells (3) each included a porous |
| chemical | surface with one or more pores (4) and electrodes for |
| sensor(s) | detection of electrochemical labels and were |
| | functionalized for affinity capture of target analytes. |
| | Each sensor also contained ten dry reagent wells (1) |
| | made of Teflon and of a volume of 9.4 μL in a well |
| | of 2 mm width by 3 mm height. Each dry reagent well |
| | (1) was placed over an analyte detection microwell |
| | (3) that included the electrochemical detector. The |
| | volume of the analyte detection microwell (3) was |
| | 0.79 μL in each well and 2 mm in width by 0.35 mm |
| | in height. The porous surface had a porosity of |
| | 0.063 mm\hat{ }2 and a sensor area of 3.1 mm\hat{ }2 per microwell |
| | for total porosity of 0.63 mm\hat{ }2 and a sensor area of 31.4 |
| | mm\hat{ }2 in all 10 microwells. |

Unless otherwise noted, all other materials were purchased from Sigma Aldrich or Thermo Fisher Scientific.

### Method to Dissolve and Mix Dry Reagents

A non-limiting embodiment or example of the present disclosure was successfully tested according to the following sequence of steps:

At 0 sec., the user adds the sample (for example 10 μL) to the reagent well (1) and starts the liquid dispensing sequence whereby a liquid reagent is added to the reagent well (1).

At 3 sec., a liquid, namely phosphate buffered saline (PBS), is dispensed (for example 94 μL) into the reagent well (1).

At 6 sec., vacuum of a set hydrodynamic force (for example 10 mBar) is applied, and the first liquid reagent is pulled into all 10 dry reagent wells (1), dissolving and mixing the dry reagents (for example, capture and detection antibodies) into 9.4 μL PBS to fill each dry reagent well (1).

At 7 sec., vacuum is shut off liquid reagent is stopped at the connecting capillary (6) at the bottom of the filtration well (5) by the porous surface. The mixed dry and liquid reagents have filled each analyte detection microwell (3) with 0.79 μL of diluted sample.. When the vacuum is off, the porous surface of the microwell (3) holds the liquid in the analyte detection microwell (3) from falling into the connecting capillary in the filtration well (5).

At 60 sec., or the after desired incubation time, the dry and liquid reagent with sample are released from microwells as the incubation and binding reactions are completed. The vacuum is turned on after desired incubation time, and the liquid starts flows through connecting capillary at the bottom of the filtration to waste. This flow rate can be adjusted based on the amount of vacuum applied. The small changes in vacuum have slower rates. A slower flow rate can allowed, for example 1 min to empty the microwell (3) which increase the binding of antibody complex to the with the microwell porous surface (for example, neutravidin affinity binding of biotinylated antibodies),.

At 2 min, the mixed liquid reagent and sample is completely removed from the analyte detection microwell (3) (for example, 10 microwells each containing 10 μL) and passes through the pores of the porous surface and flows through connecting capillary (6) at the bottom of the filtration well (5) emptying into waste below the filtration well (5). Upon collection of all waste, the vacuum is turned off, and the reagent captured on the porous surface remains behind.

At 2 min and 6 seconds, a second liquid reagent is dispensed (for example, 200 μL of washing liquid such as PBS with 0.05% TWEEN-20) into the reagent well (2) and is pulled through all 10 dry reagent wells (1) by vacuum of a set hydrodynamic force (for this example, 10 mBar or greater). The second liquid reagent is pulled through the dry reagent wells (1), the analyte detection microwell (3), and below the filtration well (5) to the waste. This sequence can be completed as many times as needed to wash un-bound materials from the analyte detection microwell (3).

At 2 min and 9 seconds, the vacuum is turned off, and an optional third liquid reagent is dispensed (for example, 100 μL of electrochemical signal generating liquid) into the reagent well (2) through the dry reagent wells (1) and the analyte detection microwell (3) and is stopped at the porous surface of the microwell (3).

At 2 min and 12 seconds, the vacuum is shut off and electrochemical signal is generated and electrochemical readings are taked. In this example, the liquid reagent generates a signal with the reagents captured on the porous surface in the analyte detection microwell (3). Optionally, this sequence can be repeated with new additional dry and liquid reagent.

At the end, the vacuum is turned on and analyte detection microwell (3) are emptied of wasted before removal by the analyst. The analyst disposes of the reacted format, namely the reagent well (2) and the filtration well (5), and can optionally save the analyte detection microwell (3) for additional analysis.

Some non-limiting embodiments do not require additional pumps, valves, or connecting capillary to allow the dry reagent to dissolve or mix with liquids. The dry reagent wells (1) may be of a larger size (e.g., 0.3 mm diameter and height of 3 mm height in an array of 10 well of 9.4 uL), and of a weaker hydrodynamic force than the porous surface at the bottom of the filtration well (5).

Accordingly, in some non-limiting embodiments, the dry reagent wells (1) contain porous materials which do not clog and allow passage of complex sample liquids at low hydrodynamic forces (e.g., a vacuum of negative 10 mbar). The added benefit of such a design is that it is very effective (>99%) at mixing dry reagents and liquids and/or samples.

Accordingly, in some non-limiting embodiments, the dry reagent wells (1) can have a much greater volume than the minimal volume needed to hold the liquid reagent. This has an additional, unexpected benefit in that an inlet and outlet capillary, or the dry reagent well entrance and exit, can be added to the area of dry reagent wells (1) to allow greater flexibility to change the volumes of the liquids, further protect the dry reagent from moisture, and further promote the mixing and dissolution of dry reagents with liquids and/or samples while still operating with a low hydrodynamic force. In a non-limiting embodiment, the delivery system may comprise a plurality of dry reagent wells (1), a plurality of analyte detection microwells (3) each with a porous surface, and a common reagent well (2).

In some non-limiting embodiments or examples, shown in FIGS. 1-6, hydrodynamic forces may be connected to a waste collection chamber for application of a hydrodynamic force via the connection to a vacuum. Hydrodynamic forces are maintained at the desired pressure in the waste collection chamber through the vacuum connection, which allows driving the sample and/or liquid reagents through a porous surface of the analyte detection microwell (3). Removing this hydrodynamic force allows the sample to be held in the analyte detection microwell (3) by the porous surface at the bottom of the analyte detection microwell (3).

In some non-limiting embodiments or examples, dissolving and mixing dry reagents with liquids occurs by moving a liquid from a reagent well (2) into dry reagent wells (1), into the analyte detection microwell (3), out through the one or more pores of the analyte detection microwell (3), and through a connecting capillary (6) placed in a filtration well (5). The dry reagent wells (1), reagent wells (2), analyte detection microwells (3), filtration well (5), and connecting capillary (6) may be assembled as one sealed device that is single use, as in once per sample or assay, but has a long stability as it is sealed and protected from moisture.

In some non-limiting embodiments or examples, dissolving and mixing dry reagents with liquids occurs in a dry reagent well (1) by dissolving and mixing dry reagents with liquids upon movement of liquid from a reagent well (2) into a dry reagent well (1), out of one or more pores of the analyte detection microwell (3), and into the connecting capillary (6) placed in a filtration well (5). The size and/or shape of dry reagent wells (1) is selected such that it does not alter the hydrodynamic force of the porous surface in the analyte detection microwell (3). Once the hydrodynamic force is removed, the liquid remains above the porous surface in the analyte detection microwell (3) and in the analyte detection microwell (3). In some examples, a dry reagent well entrance (7) and/or a dry reagent well exit (8) are added around the dry reagent well (1) to allow the dry reagent to be better dissolved and mix with liquid reagent. The dry reagent well entrance (7) and/or the dry reagent well exit (8) do not alter the hydrodynamic force of the porous surface in the analyte detection microwell (3).

In some non-limiting embodiments or examples, the analyte captured and detected in the analyte detection microwell by an affinity agent for detection is attached to a reagent capable of generating an electrochemical label. In other non-limiting embodiments, the affinity agent for analyte capture is attached to a reagent capable of binding a surface in the microwell. The electrochemical label may be detected by a working electrode and a reference electrode placed in the microwell to measure the label formed by the affinity agent for detection.

While the invention has been illustrated and described in detail in the drawings and foregoing description, the same is to be considered as illustrative and not restrictive in character, it being understood that only the representative embodiments have been shown and described and that all changes, equivalents, and modifications that come within the spirit of the inventions defined by the claims are desired to be protected. All publications, patents, and patent applications cited in this specification are herein incorporated by reference as if each individual publication, patent, or patent application were specifically and individually indicated to be incorporated by reference and set forth in its entirety herein.

1. A sample collection system configured to operate with a low hydrodynamic force, comprising:
one or more dry reagent wells;
one or more analyte detection microwells;
a filtration well; and
a reagent well.

2. The sample collection system of claim 1, wherein the one or more dry reagent wells are located above the one or more analyte detection microwells.

3. The sample collection system of claim 1, further comprising a connecting capillary.

4. The sample collection system of claim 3, wherein the connecting capillary is aligned below the one or more analyte detection microwells.

5. The sample collection system of claim 1, wherein a sample combined with liquid flows through the one or more dry reagent wells, through the one or more analyte detection microwells, and through the filtration well.

6. A method of releasing liquid into one or more dry reagent wells, the method comprising:
applying a hydrodynamic force below the one or more dry reagent wells.

7. The method of claim 6, further comprising applying a hydrodynamic force below one or more analyte detection microwells, a filtration well, and the one or more dry reagent well.

8. The method of claim 6, further comprising adding a liquid reagent for dissolving a dry reagent in the one or more dry reagent wells.

9. The method of claim 8, further comprising holding the liquid reagent for incubation in the filtration well.

10. The method of claim 9, wherein the liquid reagent moves remaining dry reagent on the porous surface by a hydrodynamic force.

11. The method of claim 6, wherein the one or more dry reagent wells comprises a first and a second set of dry reagent wells.

12. The method of claim 11, wherein a reagent in the second set of dry reagent wells dissolves dry reagent in the first set of dry reagent wells.

13. The method of claim 11, wherein the second set of dry reagent wells is placed atop the first set of dry reagent wells.

14. The method of claim 6, wherein one or more reagent wells is configured to direct liquid to the one or more dry reagent wells.

15. The sample collection system of claim 1, wherein the one or more analyte detection microwells comprises a porous surface.
